(19) United States
(12) Patent Application Publication
(10) Pub. No.: US 2005/0216256 A1
(43) Pub. Date: Sep. 29, 2005

(54) Configurable formatting system and method

(75) Inventor: Michael F. Lueck, Kitchener (CA)

Correspondence Address: BERESKIN AND PARR, 40 KING STREET WEST, BOX 401, TORONTO, ON, M5H 3Y2, CA

(73) Assignee: Mitra Imaging Inc., Waterloo (CA)

(21) Appl. No.: 10/810,564

(22) Filed: Mar. 29, 2004

(51) Int. Cl. G06F 17/28

(52) U.S. Cl. 704/10

(57) ABSTRACT

A configurable formatting system and method for generating a desired representation of an expression within a word list includes a dictionary database, a working list module, a formatting module, and a configuration file. The dictionary database stores categories containing words and translation rules. The configuration file contains variants to the contents of the categories of the dictionary database and is used to overwrite those in the dictionary database at startup. The working list module is used to read a word from the word list and to determine whether the word is associated with the expression. If so the word is inserted into a word list. The word list is processed when a word is read that is associated with the termination of the expression. The formatting module processes the words from the working list and generates the desired representation of the expression from the working list.

### FIELD OF THE INVENTION

This invention relates generally to the field of speech recognition and more particularly to a configurable formatting system and method for translating expressions into a desired representation of the expression.

### BACKGROUND OF THE INVENTION

Commercially available speech recognition systems utilize various techniques to convert expressions within recognized text into an intelligible representation of that expression. That is, the textual output provided by speech recognizers can include terms that specify dates, times, telephone numbers, and the like to prevent time-consuming manual editing of textual output when such instances occur within the spoken text.

For example, U.S. Pat. No. 5,970,449 to Alleva et al. discloses a text normalizer that normalizes text that is input from a speech recognizer. The normalization of the text produces text that is less awkward and more familiar to recipients of the text. Text normalization is performed using a context-free grammar which includes rules that specify how text is to be normalized. The context-free grammar is extensible and may be readily changed. Also, U.S. Pat. Nos. 6,493,662 and 6,513,002 to Gilliam disclose a number translation engine that is based on a textual description of the procedure for spelling out a number in any of a variety of languages. The number translation engine comprises an output alphabetical representation formatter that in turn comprises a formatting engine and rule set.

However, these prior art speech recognition systems, identify and translate expressions according to predefined context-free grammars. They do not provide dynamic translation capabilities and requires complex configuration to achieve translation of more complex expression representations.

### SUMMARY OF THE INVENTION

The invention provides in one aspect, a configurable formatting system for generating a desired representation of an expression within a word list, said system comprising:
(a) a dictionary database for storing at least one category, said category containing at least one word and at least one translation rule;
(b) a configuration file coupled to the dictionary database containing at least one variant to the contents of at least one category of the dictionary database, said variant to the contents of at least one category being used to overwrite the contents of said at least one category within said dictionary database;
(c) a working list module coupled to the dictionary database for reading a word from the word list and identifying whether a word is associated with the expression by searching the categories of said dictionary database for said word, said working list module being adapted to:
   (i) insert the word into a working list if the word is associated with the expression;
   (ii) process the word list when the word is associated with the termination of the expression; and
(d) a formatting module coupled to the working list module for processing the words from the working list and generating the desired representation of the expression from the working list.

The invention provides in another aspect, a configurable formatting method for generating a representation of an expression within a recognized word list, said method comprising:
(a) storing at least one category in a dictionary database, said category containing at least one word and at least one translation rule;
b) storing at least one variant to the contents of at least one category of the dictionary database in a configuration file and using the contents of at least one category to overwrite the contents of said at least one category within said dictionary database;
(c) reading a word from the word list and identifying whether the word is associated with the expression by searching the categories of said dictionary database for said word;
(d) inserting the word into a working list if the word is associated with the expression;
(e) processing the word list when a word is associated with the termination of the expression; and
(f) formatting the words from the working list and generating the desired representation of the expression from the working list.

Further aspects and advantages of the invention will appear from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show some examples of the present invention, and in which:

FIG. 1 is block diagram of the configurable formatting system of the present invention;

FIG. 2 is a flowchart illustrating the basic operational steps of the configurable formatting system of FIG. 1;

FIG. 3 is a schematic diagram of an example working list maintained by the working list module and utilized within the configurable formatting system of FIG. 1;

FIG. 4A is a schematic diagram illustrating the relationship of a word, its context match type, its attributes and its translation as stored in the dictionary database of FIG. 1;

FIG. 4B is a finite state machine representation of the two context match types that are defined within formatting system of FIG. 1;

FIG. 4C is an example configuration file of FIG. 1;

FIG. 5 is a flowchart illustrating the process steps conducted by the next word reader module of FIG. 1;

FIG. 6 is a flowchart illustrating the process steps conducted by the formatting module of FIG. 1;

FIG. 7 is a flowchart illustrating the process steps conducted by the add to working list module of FIG. 1; and

FIG. 8 is a flowchart illustrating the process steps conducted by the working list module of FIG. 1.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

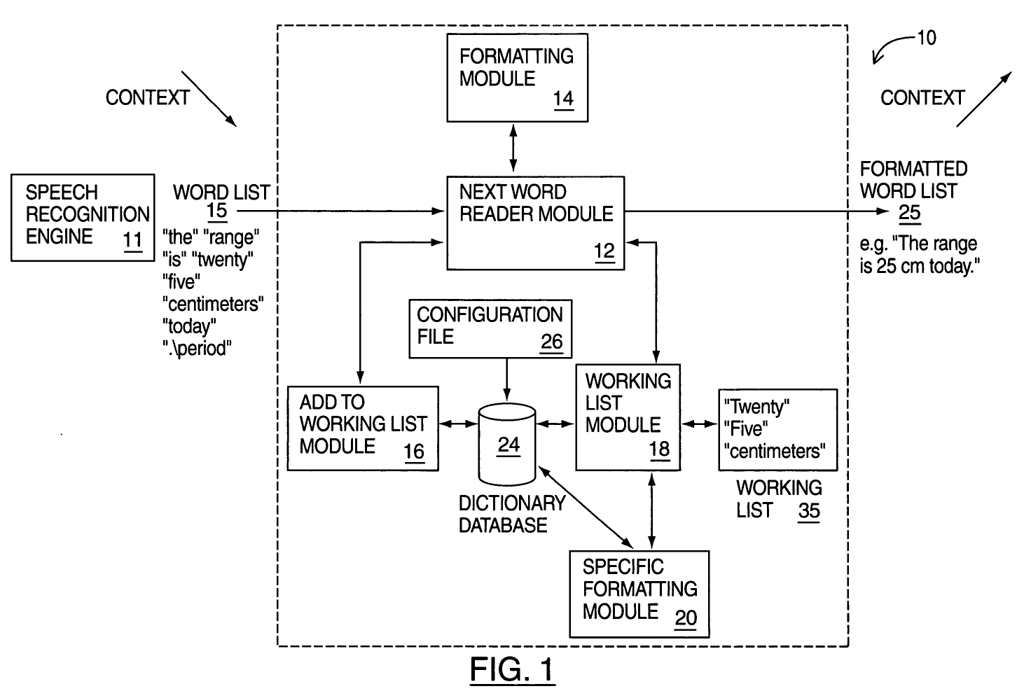

Reference is first made to FIG. 1, which illustrates the basic elements of configurable formatting system 10 made in accordance with a preferred embodiment of the present invention. Formatting system 10 includes a next word reader module 12, a formatting module 14, an add to working list module 16, a working list module 18, a specific formatting module 20, a dictionary database 24 and a configuration file 26. As shown, formatting system 10 receives a word list 15 (i.e. a series of words identified in a phrase) from a speech recognition engine 11 and dynamically and contextually generates a formatted word list 25 that provides meaningful representations of expressions. Formatting system 10 recognizes complicated expressions which can include numbers and “word-in-number” combinations and translates them into intelligible representations of those expressions through the use of dynamic contextual rules, as will described. Configuration file 26 is used to customize dictionary database 24 such that a specific user (e.g. a radiologist) can define particular formatting rules for use within formatting system 10.

Speech recognition engine 11 is a conventionally known speech recognition engine program and is preferably implemented using a SAPI 4 compliant voice recognition engine, namely Dragon Naturally Speaking™ (manufactured by ScanSoft of Massachusetts, U.S.A.). However, it should be understood that any conventional speech recognition software that provides textual output could be utilized by formatting system 10 (e.g. ViaVoice manufactured by IBM of White Plains, N.Y., U.S.A. and Speech SDK 3.1™ product manufactured by Philips Speed Processing (PSP) of Austria.) In addition, it should be understood that while it preferred for formatting system 10 to be used as a further processing step for voice recognition, formatting system 10 is not restricted to voice recognition applications.

As shown in FIG. 1, next word reader module 12 receives a word list 15 from a speech recognition engine 11. Each word list 15 consists of a series of individual words recognized by a speech recognition engine and generally corresponds to a recognized phrase. As is conventionally known, speech recognition engine 11 determines the amount of silence within input spoken text and when there has been sufficient silence (i.e. a pause) around a number of words, the preceding words are considered to belong together in a phrase. Next word reader module 12 utilizes add to working list module 16 to determine whether a particular word within word list 15 is considered “significant” and should be added work working list 35 as will be described in more detail.

Add to working list module 16 is used by next word reader module 12 to determine whether a particular word is “significant”. That is, add to working list module 16 determines whether a particular word should be added to working list 35. A word within word list 15 is considered “significant” if dictionary database 24 (as augmented by configuration file 26 on startup) provides that the word is associated with an expression that is desirable to translate into a formatted expression. Specifically, a number of “attributes” and “contexts” are used to define various categories of words that are considered “significant”. These defining attributes and contexts are stored within dictionary database 24 and are used to define significant word categories as will be described. What is considered to be “significant” will change dynamically depending on the particular combination of words being read from word list 15 and the context of formatting system 10 as will be described. Add to working list module 16 receives the word from next word reader module 12 and queries dictionary database 24 to see whether the word falls into any of the significant word categories defined by dictionary database 24.

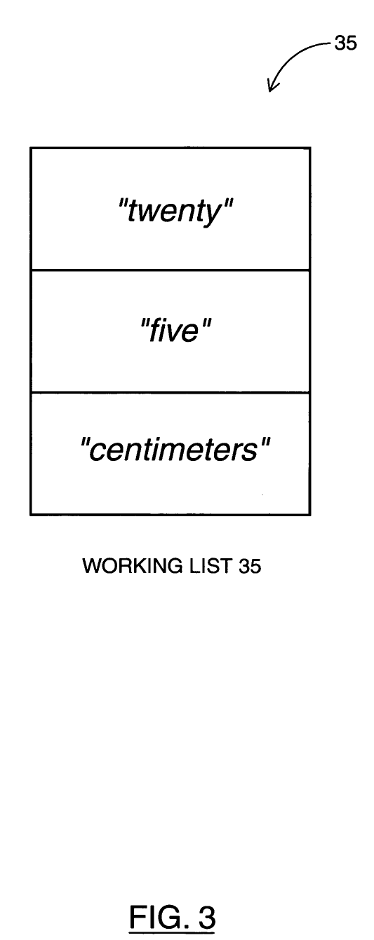

Working list module 18 is used to create a working list 35 (FIG. 3) that contains words that are have been identified by add to working list module 16 as being associated with a particular expression. Specifically, working list module 18 adds a word from word list 15 to working list 35 if the word is considered to be “significant” by add to working list module 16 as defined above. Working list module 18 groups words together within working list 35 in order to format them based on their associated attributes and context. Conversion techniques are then used to translate the words that have been collected within working list 35. That is, words associated with an expression are converted into a desired formatted representation of the expression.

Accordingly, working list 35 is a collection of words from the word list 15 that are all considered “significant” and which require formatting either alone or in conjunction with other words in the working list 35. Working list module 18 also identifies words within the word list 15 that are defined by dictionary database 24 as being “Terminator” words. Terminator words indicate that working list 35 must be processed before any additional words can be added to working list 35. When next word reader module 12 identifies that the word being read from word list 15 is a Terminator word, it causes working list module 18 to process working list 35. Examples of a Terminator word are: “eighths”, “hundred”, “centimeters” (i.e. in the expression “twenty five centimeters”) etc. As will be described there are other types of words which act to trigger the processing of working list 35.

Dictionary database 24 and configuration file 26 are used together to define how words are transformed into intelligible textual representations. Dictionary database 24 and configuration file 26 both contain translation rules that define word categories of “significant” words as discussed above. When formatting system 10 is first activated (i.e. at startup), the entries within configuration file 26 are used to overwrite the contents of dictionary database 24. Dictionary database 24 and configuration file 26 each store a variety of word categories, each of which include translation rules that are utilized by next word reader module 12 to translate words. The “word” element of a translation rule defines a “significant” word and the “translation” element of a translation rule is what the “significant” word is translated into.

Configuration file 26 includes a number of user-definable exclusions to the translation rules listed in dictionary database 24 and these exclusions are used to overwrite the corresponding translation rules in dictionary database 24. As discussed above, a user (e.g. a radiology department) may have certain translation preferences that can be accommodated within formatting system 10. For example, one department may prefer the translation “2 centimeters” whereas another would prefer “2 cm”. Alternatively, it may be preferred to format dates as “20/08/2003” instead of “Aug. 20, 2003”. Accordingly, while the default translation rules provided in dictionary database 24 includes the translation rule: “centimeters” to “cm”, a listing within configuration file 26 that provides the translation rule “centimeters” to “centimeters” will overwrite the translation rule: “centimeters” to “cm” rule provided in dictionary database 24 at startup. This will result in the word “centimeters” being translated into “centimeters” when encountered (i.e. the word will not be changed).

Formatting module 14 is utilized by next word reader module 12 to format words for both “significant” and “insignificant” words. Formatting module 14 performs various formatting functions on the word (e.g. adding a space in front of the word, capitalizing the first letter of the word if it is at the beginning of a phrase, etc.) so that it is ready for presentation within formatted word list 25. Formatting functions include formatting procedures such as adding spaces and/or capitalization.

Specific formatting module 20 is used by working list module 18 to format words within working list 35. Specific formatting module 20 utilizes information stored in dictionary database 24 to translate an expression into an appropriately formatted representation of the expression. As before, formatting module 14 is used by next word reader module 12 to perform general formatting of “significant” words that have already been pre-formatted by specific formatting module 20. Again, formatting module 14 will provide such general formatting as adding a space on one side of a word and/or capitalization.

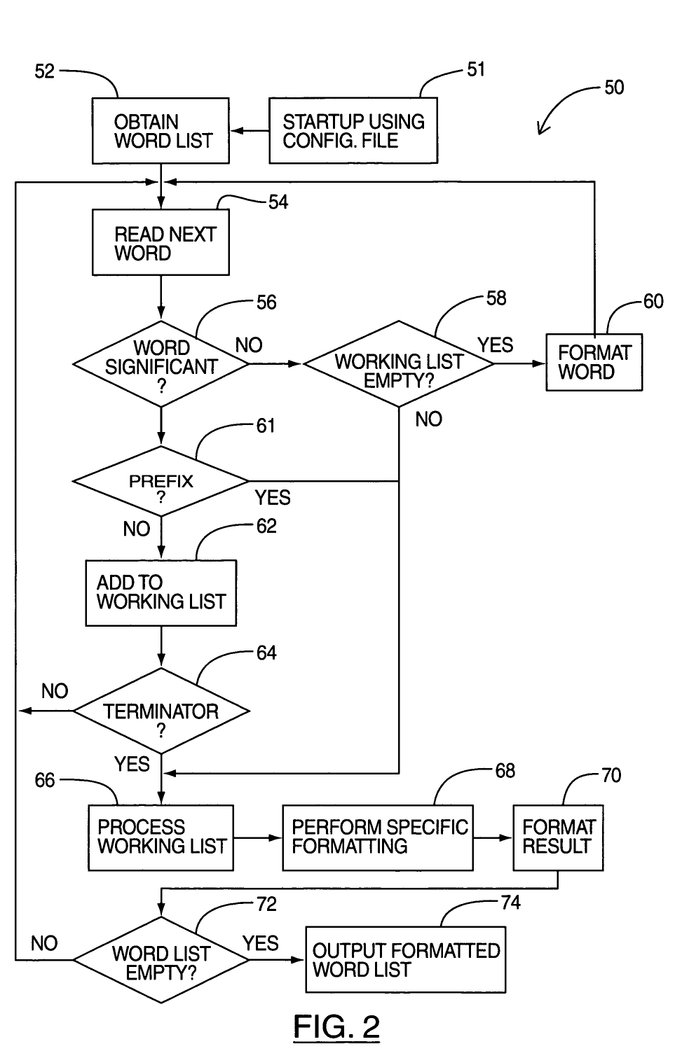

Referring now to FIGS. 1 and 2, the basic operation steps (50) of formatting system 10 is illustrated. Specifically, FIG. 2 illustrates how word list 15 is transformed into formatted word list 25.

At startup, at step (51), configuration file 26 is used to pre-configure dictionary database 24 and any desired “overwrites” are completed within dictionary database 24. Also, it should be understood that as shown in FIG. 1, the specific “context” of formatting system 10 is kept track of and after each word list 15 has been processed and put into formatted word list 25 the exiting “context” is used as the initial context for the next word list 15. At step (52), speech recognition engine 11 provides word list 15 to next word reader module 12 using conventionally known voice recognition techniques. At step (54), next word reader module 12 reads the next word and at step (56), add to working list module 16 reads dictionary database 24 and determines whether the word is considered “significant”. If the word being read is not considered to be “significant”, then at step (58), it is determined whether working list 35 is empty.

If so then at step (60), formatting module 14 formats the word and then next word reader module 12 will read the next word at step (54). The kind of formatting provided by formatting module 14 is general formatting such as addition of a space in front of the word and/or capitalization as required. For example, the words from word list 15 “the”, “range” and “is” could all be considered not to be important words for the purposes of expression formatting if all that is being formatted are numerical expressions. Since the working list is empty (no relevant words have been added to the working list yet) then these words would be formatted into the strings: “The”, “_range”, and “_is”. When these words are combined later they will form the initial words of the phrase “The range is”. If the working list is not empty then at step (66), working list module 18 processes the word entries within working list 35 since an insignificant word (i.e. a word not found within dictionary database 24) is also used within formatting system 10 as a trigger to process working list 35.

It should be understood that there are three situations under which working list 35 will be triggered to be processed. The first situation is the case where there are words in the working list 35 and a word is determined not to be significant by next word reader module 12 (i.e. a word that does not fall within the word categories defined by dictionary database 24). The presence of an “insignificant” word means that all words associated with an expression have been read and that they are all in working list 35. That is, if at step (56), the word read is determined not to be significant and then at step (58), working list 35 is found not to be empty, then at step (66), working list 35 is processed.

The second situation is when next word reader module 12 reads a “Prefix” word. At step (56), if the word read is determined to be “significant”, then at step (61), next word reader module 12 determines whether the word is a “Prefix” word. A Prefix word is used within formatting system 10 to signal that there may be an expression for formatting following. Accordingly, a Prefix word always causes working list 35 (i.e. a previous expression) to be processed. If at step (61), the word read is determined to be a Prefix word then at step (66), the words within working list 35 will be processed and formatting according to various context-dependent rules as will be described. If the word read is determined at step (61) not to be a Prefix word then at step (62), add to working list module 16 adds the word to the working list 35 (see FIG. 3).

The third situation is where next word reader module 12 reads a “Terminator” word. At step (64), next word reader module 12 determines whether the word read is a “Terminator” word. A Terminator word is a word that always causes working list 35 to be processed (e.g. “eighth” “centimeter”, “hundred”, etc.) A Terminator word is used by formatting system 10 to trigger processing (i.e. formatting) of the words within working list 35 before any additional words can be added to working list 35. If the word being read is identified as being a Terminator word, then at step (66) working list module 18 will begin processing working list 35. Specifically, at step (68), the words within working list 35 will be specifically formatting according to various context-dependent rules as will be described. Specific formatting at step (68) includes such transformations as a number in text format (e.g. “twenty five”) into a number in numerical format (e.g. “25”). Another example would be the translation of a number in text format surrounded by associated words (e.g. “twenty” “five” “centimeters”) that represent a word-in-number expression (e.g. “25 cm”).

After the words in working list 35 have been specifically formatted, the resulting expression generated by specific formatting module 20 is then generally formatted by formatting module 14 at step (70). Formatting module 14 provides formatting of the complete expression result (e.g. “25 cm” into “_{—}25 cm”). At step (72), next word reader module 12 determines whether word list 15 is empty. If so, then at step (74), formatting module 14 takes all formatted words and expression results and provides formatting word list 25 (e.g. “The range is 25 cm today”.).

It should be understood that while the particular example embodiment of formatting system 10 is directed to the formatting of words associated with a numerical expression into a desired representation of the numerical expression, formatting system 10 could be used to format any type of expression into a desired representation of that expression. For example, if it were desired to remove all instances of a particular word or expression (e.g. a profanity), it would be possible to include translation rule(s) within dictionary database 24 that cause add to working list module 16 to identify that the word(s) are associated with an expression so that the word(s) are inserted into working list 35 and finally so that they are formatted by specific formatting module 20 into a desired representation of the expression (e.g. to replace a profanity with “” so that empty space replaces the profanity in the formatted expression).

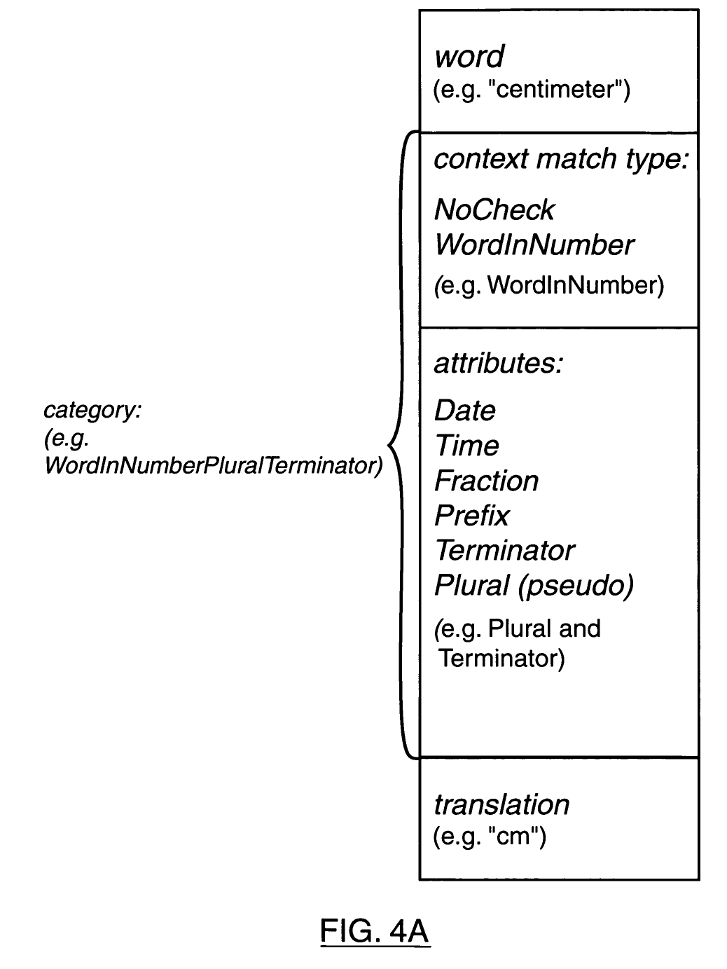

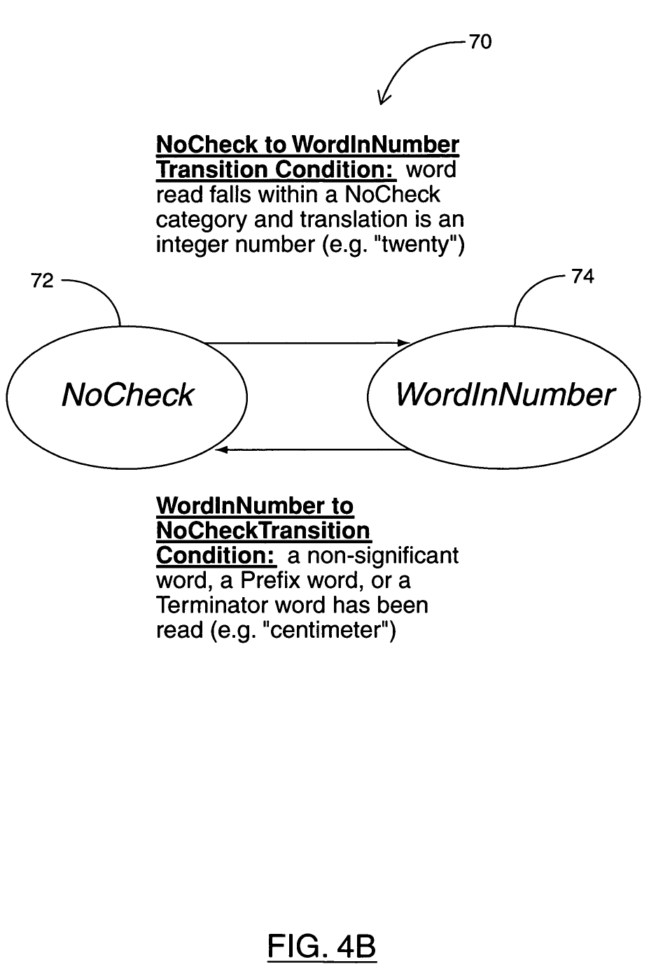

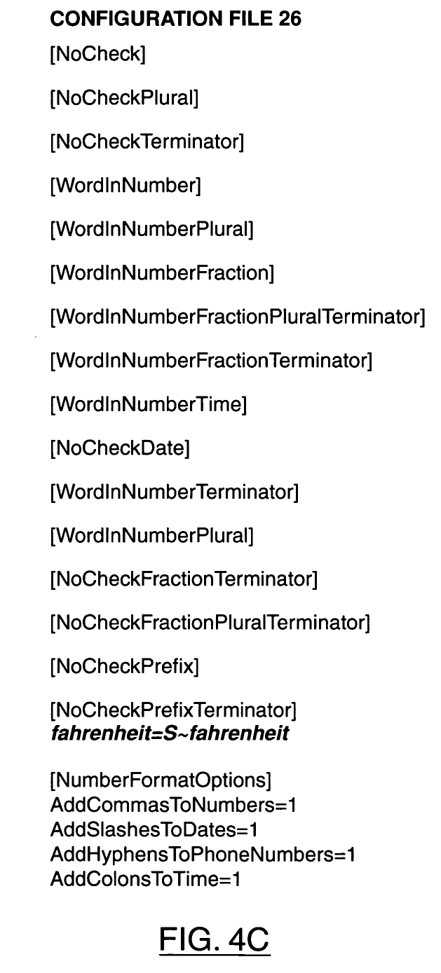

FIGS. 4A, 4B and 4C are schematic diagrams that illustrate the function, structure, and relationship of the information stored in dictionary database 24 utilized by formatting system 10 to identify expressions and format them into formatted textual representations of the expressions.

FIG. 4A illustrates the relationship between a particular word (e.g. “centimeter”), the context match type associated with that word (e.g. “WordInNumber”), the attributes of that word (e.g. “Plural” and “Terminator”) and the translation of the word (e.g. “cm”). The context match type associated with a word is utilized by formatting system 10 to determine whether the word is considered “significant” (i.e. whether it will be added to working list 35). Attributes associated with a word indicate(s) how the word can be used, how the working list 35 should be processed (e.g. Prefix, Terminator), and how to format the words themselves (e.g. Date, Time). The associated set of attributes (e.g. Fraction, Prefix, Terminator, etc.) provide additional information about the word. The translation associated with a word indicates what the word will be translated into by working list module 18. The translation can be either of “integer” format (i.e. number) or it can be of “string” format (i.e. a word). The context match type and the attributes of a particular word are combined to form a category for that word as shown in FIG. 4A. The specific context match types, attributes and categories utilized within the example formatting system 10 are discussed below.

Context Match Type

FIG. 4B illustrates a finite state machine representation 70 of the NoCheck and WordInNumber context match types 72 and 74 that are defined for formatting system 10. Whether the context of formatting system 10 is a NoCheck or WordInNumber context match type 72 or 74 depends on whether the words being read by next word reader module 12 satisfy the associated transition conditions. While in the example implementation, the context of formatting system 10 begins in the NoCheck context match type 72 at startup, it should be understood that in the case where expressions cross phrases (i.e. are broken up into phrases) it would not necessarily be the case that the context of formatting system 10 begin in the NoCheck context match type. The context of formatting system 10 used in combination with the category (if any) of a particular word just read by next word reader module 12 to determine whether the next word read from word list 15 is considered “significant”. If the next word read from word list 15 is determined to be “significant” then it is added to the working list 35.

Two example contextual states are as set out in Table A. It should be understood that many other contextual states could be defined within formatting system 10.

TABLE A
Context Match Types

| Context | | Examples Words |
|---|---|---|
| Match Type | Meaning | added to Working List |
| NoCheck | only words in a “NoCheck” | “five”, “ounce”, “january” |
| | categories are added to | |
| | working list | |
| WordinNumber | words in the “NoCheck” | “five”, “ounce”, “january” |
| | and “WordInNumber” | as well as |
| | categories are added to | “third”, “am”, “pm”, “and” |
| | working list | |

Referring now to FIG. 4B, the context of formatting system 10 dynamically changes as words are read from word list 15. The context of formatting system 10 depends in part on whether a particular word just read is considered to be “significant” or not. Specifically, the context of formatting system 10 begins (i.e. defaults at startup) as a NoCheck context match type. As next word reader module 12 reads words from word list 15, it is determine whether the context of formatting system 10 should transition to the WordInNumber context match type. In the particular example of formatting system 10 being discussed, if the NoCheck to WordInNumber transition condition is met then the context of formatting system 10 moves from the NoCheck context match type to the WordInNumber context match type. The context of formatting system 10 continues to be of a WordInNumber context match type until a insigificant, Terminator, or Prefix word has been read by next word reader module 12.

In the example, when formatting system 10 is first activated (i.e. on startup), the context of formatting system 10 begins in the NoCheck context match type. When next word reader module 12 reads the first word “the” in word list 15 (as shown in FIG. 1) from word list 15 the context of formatting system 10 remains as a NoCheck context match type. This is because the word “the” does not satisfy the NoCheck to WordInNumber transition condition for being a WordInNumber context match type, namely, the word “the” does not fall within a NoCheck category (FIG. 4B).

On reading the words “range” and “is” from word list 15 (FIG. 1) the context of formatting system 10 remains as a NoCheck context match type state since none of these words satisfy the NoCheck to WordInNumber transition condition either. When next word reader module 12 reads the word “twenty”, add to working list module 16 determines that the word “twenty” is a “significant” word since “twenty” is listed in dictionary database 24 within a NoCheck category and since its listed translation is an integer number (i.e. “20”). A word that belongs to a NoCheck category within dictionary database 24 is always considered “significant” regardless of the context of formatting system 10. A word that belongs to a WordInNumber category within dictionary database 24 is only considered “significant” if the formatting system 10 is a WordInNumber context match type. Since “twenty” is a NoCheck category word and the translation of “twenty” is an integer number, the context of formatting system 10 becomes a WordInNumber context match type and the word “twenty” is added to working list 35 (FIG. 3).

When next word reader module 12 reads the next word, namely “five”, add to working list module 16 determines that the word “five” is a “significant” word since “five” is listed in dictionary database 24 within a NoCheck category which means that such a term is always considered “significant” regardless of the context of formatting system 10 (which is now a WordInNumber context match type). Accordingly, add to working list module 16 adds the word “five” to working list 35 (FIG. 3). When next word reader module 12 reads the next word, namely “centimeters”, add to working list module 16 determines that the word “centimeters” is a “significant” word since “centimeters” is listed in dictionary database 24 within a WordInNumber category as a Terminator word.

Since the context of formatting system 10 is a WordInNumber context match type and since the WordInNumber to NoCheck transition condition is satisfied (i.e. since “centimeter” is a Terminator word), add to working list module 16 adds the word “centimeters” to working list 35 (FIG. 3) and the processing of working list 35 is triggered as discussed above. After working list 35 is processed and formatted, the formatted word list 25 will include “The range is 25 cm”. The next word read is “today” and since this word is considered “insignificant” (i.e. not present within any of the categories within dictionary database 24) and since working list 35 is empty, the word “today” is simply formatted and included in formatted word list 25.

The context of formatting system 10 is defined using context indicia. Table B sets out a number of example context indicia for formatting system 10. It should be should be understood that many other context indicia could be utilized within formatting system 10. The context of formatting system 10 changes as words are read from word list 15 and as the values of the various context indicia change. A particular context indicia can be defined to be of a certain value type (e.g. Boolean or Integer, etc.) and the values that it can take on will be defined accordingly.

Whether the context of formatting system 10 is of the NoCheck context match type or the WordInNumber context match type is determined by examining the values of the context indicia that are considered “important” for that particular context match type. For the context indicia that are considered “important’ for a particular context match type, it is determined whether they are of a certain required value. As can be seen from Table B, in the NoCheck context match type, none of the context indicia are considered important and this is indicated by the “x”'s in the appropriate column. Accordingly, the value of any of these context indicia is inconsequential. In contrast, in the WordInNumber context match type, the InNumber context indicia is defined as being important (since it is indicated by a “√”) and its required value is “TRUE”.

TABLE B
Context Indicia

| | | | Important | |
|---|---|---|---|---|
| | | | to | Important to |
| Context | | | NoCheck? | WordInNumber? |
| Indicia | Type | Meaning | (VALUE) | (VALUE) |
| JoinLeft | boolean | join the word | x | x |
| | | to the word | | |
| | | preceding | | |
| PadLeft | integer | insert integer | x | x |
| | | number of | | |
| | | space at the | | |
| | | left side of | | |
| | | the word | | |
| PadRight | boolean | insert a | x | x |
| | | space at | | |
| | | the right | | |
| | | side of the | | |
| | | word | | |
| CapitalizeNext | boolean | capitalize the | x | x |
| | | first letter in | | |
| | | the next | | |
| | | word | | |
| UpperCaseNext | boolean | apply upper | x | x |
| | | case to the | | |
| | | next word | | |
| LowerCaseNext | boolean | apply lower | x | x |
| | | case to the | | |
| | | next word | | |
| CapOn | boolean | capitalize all | x | x |
| | | of the letters | | |
| | | in the next | | |
| | | word | | |
| InNumber | boolean | indicates the | x | ✓ |
| | | word is in a | | (TRUE) |
| | | numerical | | |
| | | expression | | |

When evaluating whether the context of formatting system 10 is within a particular context match type, it is only necessary to check the value of the context indicia that are defined to be “important” for that context match type. That is, to determine whether the context of formatting system 10 is a NoCheck context match type, it is not necessary to check the value of any of the context indicia since none of them are considered “important” (i.e. they are all marked with “x”'s). When checking whether the context of formatting system 10 is a WordInNumber context match type, the value of the InNumber context indicia must be examined. If the value of the context indicia InNumber is “TRUE” then the context of formatting system 10 is in the WordInNumber context match type.

The JoinLeft context indicia is used by formatting system 10 to trigger formatting module 14 to output a word from working list 35 into formatted word list 25 without a space in front of it. This allows for formatting system 10 to output words that are concatenated together (i.e. without spaces in between them).

The PadLeft context indicia is used by formatting system 10 to trigger formatting module 14 to output a word from working list 35 into formatted word list 25 with an integer number of spaces (i.e. 0, 1, 2, . . . ) inserted before the word. This allows formatting system 10 to output words that have a certain number of spaces inserted before the word.

The PadRight context indicia is used by formatting system 10 to trigger formatting module 14 to output a word from working list 35 into formatted word list 25 with a single space inserted after the word. This allows formatting system 10 to output words that have a space inserted after the word.

The CapitalizeNext context indicia is used by formatting system 10 to trigger formatting module 14 to output a word from working list 35 into formatted word list 25 having its first letter capitalized. Typically, formatting system 10 would enter into this state after encountering a word that is end of sentence punctuation (e.g. “.\period”).

The UpperCaseNext context indicia is used by formatting system 10 to trigger formatting module 14 to output a word from working list 35 into formatted word list 25 in upper case format.

The LowerCaseNext context indicia is used by formatting system 10 to trigger formatting module 14 to output a word from working list 35 into formatted word list 25 in lower case format.

The CapsOn context indicia is used to determine whether a word from working list 35 should beTypically, formatting system 10 would enter into this state when the user has turned the “caps” on (i.e. the word “\capson” has been detected in word list 15).

The InNumber context indicia is used to determine whether a word from working list 35 is to be considered as being within an expression. For example, the InNumber context indicia would be “TRUE” if a numerical value had been encountered. As discussed above, the context of formatting system 10 will be a WordInNumber context matching type if the InNumber context indicia is “TRUE”.

Attributes

The attributes associated with a word within a working list 35 are also used (along with the context of formatting system 10) to determine how that word gets transformed when working list module 18 processes working list 35. In the example embodiment of formatting system 10 discussed, five different kinds of attributes are used as set out in Table C.

TABLE C

| Attributes | | |
|---|---|---|
| Attribute | Meaning | Example Formatting Action |
| Fraction | causes formatting of | “thirds” to “3” |
| | word into fraction format | “half” to “2” |
| Date | causes formatting of the | “January” to “01” |
| | word into a particular | “January” to “January” |
| | date format; applies | |
| | ordinals where | |
| | appropriate | |
| Time | causes formatting of the | “eight thirty pm” to “8:30 p.m.” |
| | word into a particular | “hours” to “hr” |
| | time format | |
| Prefix | translate number that | “numeral five” to “5” |
| | follows to numerical | |
| | format; also used to | |
| | indicate that the | |
| | previous expression is | |
| | complete (i.e. process | |
| | word list) | |
| Terminator | triggers processing of | “eighth”, “hundred”, |
| | working list | “centimeter” |

A word is said to have a fraction attribute if it is to be translated into fraction format (e.g. “thirds”, “half”, etc.) When specific formatting module 20 encounters a word having a fraction attribute, the word is then translated into the appropriate numerical representation (e.g. “3”, “2”, etc.) and the appropriate fraction formatting (i.e. using a “/” etc.) is applied as will be further described in relation to the workings of specific formatting module 20.

Words having the date attribute are formatted into a desired date format (e.g. “January” to “01”) by specific formatting module 20. It is possible to have no particular formatting occur by inserting translation rules that convert a word (e.g. “January”) to the identical word (e.g. “January”). It should be understood that many different date formats are possible including European-style date formatting (e.g. “01.03.04”) and the like.

Words with the time attribute are formatted into a desired time format (e.g. “pm” to “p.m.”, “hours” to “hr” etc.) by specific formatting module 20. Again, many different formatting styles can be implemented by formatting system 10.

Prefix words are used to indicate to specific formatting module 20 that the expression that follows the Prefix word is to be formatted in a particular way. A Prefix word is also used to indicate that the expression associated with any preceding words is complete and that the working list 35 is to be processed. In the present example of formatting system 10, a Prefix word is used to indicate that the words following are to be translated into a numerical representation of the expression and that the expression associated with any preceding words is complete and that the working list 35 should be processed.

Practically speaking, when a Prefix word is read it is stored in abeyance pending words that follow. If the words that follow (e.g. “five”) are part of an expression that is desired to be specially formatted (e.g. a numerical expression) then the Prefix word and the words that follow are inserted in working list 35 and processed accordingly (i.e. into “5”). In contrast, a Prefix word utilized within word list 35 that is followed by a word (e.g. “truck”) that does not form part of an expression to be translated are not entered into working list 35 and are merely formatted by next word reader module 12 and output into formatted word list 25 (i.e. as “numeral truck”).

Typically, working list module 18 reads words from working list 35 by from left to right, although there are exceptions to this rule. Specifically, as noted above, if a word has the attribute “Prefix” then it is considered to indicate that the upcoming words form part of an expression that requires formatting. In addition, a Prefix word indicates that an expression (if any) that preceded the Prefix word has been completed and that working list 35 should be processed. Accordingly, in some cases, when processing a Prefix word it is necessary to hold the Prefix word while processing the words that preceded the Prefix word.

As described above, Terminator words (along with Prefix words and insignificant words) are recognized by formatting system 10 as indicating that working list 35 must be processed before any additional words can be added to working list 35. An example of a Terminator word is “centimeters” (i.e. in the expression “twenty five centimeters” of FIG. 1). The associated working list 35 for the example in FIG. 1 will contain the words “twenty”, “five” and “centimeters” (FIG. 3). Once the word “centimeters” is read by next word reader module 12, add to working list module 16 determines that it should be added to working list 35. Working list module 18 then determines that since a Terminator word has been added that working list 35 should be processed. Specific formatting module 20 processes working list 35 and the resulting representation of the expression is “25 cm”.

In addition, formatting system 10 utilizes a quasi-attribute “plural” that provides for processing economy. When this term is used in association with a word category within dictionary database 24, specific formatting module 20 translates the word either in singular or plural form to the same translation. As an illustration, if a word is considered to be associated with the attribute object of “Plural” then when the word is being formatted in a working list 35, it will be translated into the same translation regardless of whether it is singular or plural (e.g. “centimeter” or “centimeters” to the translation “cm”). The “plural shortcut” allows multiple terms in dictionary database 24 to be efficiently represented.

Categories

The two possible context match types (e.g. NoCheck and WordInNumber) of the example formatting system 10 are selectively combined together with these attributes (including the “plural” quasi-attribute) to form sixteen different categories within dictionary database 24. It should be understood that this is only an example of a working formatting system 10 and that there could be greater or fewer categories defined within formatting system 10 depending on the particular formatting functionality desired.

Each category defines a set of particular actions that will be taken in respect of a word that is defined to fall within the category when working list module 18 processes working list 35. Accordingly, by grouping words together with similar attributes in these categories, it is possible to more effectively and efficiently define the specific processing steps to be applied to various words in working list 35. The categories contained within dictionary database 24 of the example embodiment of formatting system 10 are as set out in Table D. It should be noted that the each category contains at least a context (in bold) within which words are intended to be considered “significant”. Also, a category can contain one or more attributes (underlined).

TABLE D
Categories

| Category | | |
|---|---|---|
| Context (BOLD) | | |
| Attributes and pseudo- | | |
| attributes (UNDERLINED) | Action To Be Taken | Example Words in Category |
| αNoCheck | translate to translation | “oh” to “0” |
| | | “one” to “1” |
| | | “twenty” to “20” |
| αNoCheckPlural | translate both singular | “ounce” or “ounces” |
| | and plural words to the | to “oz” |
| | same translation | “pint” or “pints” to |
| | | “pt” |
| αNoCheckTerminator | triggers processing of | “first” to “1” |
| | working list and | “second” to “2” |
| | translate to translation | |
| αWordInNumber | translate as a | “hundred” to “100” |
| | WordInNumber string | “thousand” to “1000” |
| αWordInNumberPlural | translate singular and | “dollar” and “dollars” |
| | plural to the same | to “$” |
| | translation | |
| | translate as a | |
| | WordInNumber string | |
| WordInNumberFraction | perform fraction | “over” to “/” |
| | formatting | |
| | translate as a | |
| | WordInNumber string | |
| WordInNumberFractionPlural | process working list | “half” to “2” |
| Terminator | perform fraction | “quarter” to “4” |
| | formatting | |
| | translate singular and | |
| | plural to the same | |
| | translation | |
| | translate as a | |
| | WordInNumber string | |
| WordInNumberFractionTerminator | process working list | “thirds” to “3” |
| | perform fraction | “fourths” to “4” |
| | formatting | “eights” to “8” |
| | translate as a | |
| | WordInNumber string | |
| WordInNumberTime | perform time formatting | “pm” to “p.m.” |
| | translate as a | |
| | WordInNumber string | |
| NoCheckDate | perform date | “January” to |
| | formatting | “January” |
| WordInNumberTerminator | translate as a | “celsius” to “C” |
| | WordInNumber string | “feet” to “ft” |
| | process working list | |
| WordInNumberPluralTerminator | process working list | “centimeter” to “cm” |
| | translate singular and | “meter” to “m” |
| | plural to the same | |
| | translation | |
| | translate as a | |
| | WordInNumber string | |
| NoCheckFractionTerminator | process working list | “third” to “3” |
| | perform fraction | “fourth” to “4” |
| | formatting | |
| NoCheckPrefix | process working list | “numeral” to “” |
| | translate following | |
| | word into numerical | |
| | format | |
| NoCheckPrefixTerminator | process working list | “<profanity>” to “” |
| | translate following | |
| | word into numerical | |
| | format | |

Accordingly, each category contains a context that indicates when a word would be considered “significant” by formatting system 10. Each category can also contain one or more attribute, although it possible to have a category that only consists of a context (e.g. “NoCheck”). That is, the various categories are built from selective combinations of contexts and attributes provide formatting system 10 with an effective way to process words within working list 35. Each category identifies the properties of the words that are contained within it and contains translation rules that are to be executed due to the properties associated with all the words in the particular category.

The action to be taken for a particular word that has been identified within dictionary database 24 depends in part on the translation rule that is associated with a particular word in a category. The preferred format of the translation rules utilized by formatting system 10 is:
<word>=<type>˜<translation>When add to working list module 16 searches dictionary database 24 to determine whether a word being read from working list 35 is “significant”, all defined “words” of all the translation rules are searched for that word. The “type” is defined being “S” which stands for “string” or “I” for “integer”. If a translation rule includes an “I” type, then the rule is subject to the rules for combining numbers (e.g. “one hundred and twenty five” being translated into “125”). It should be understood that while only these types are utilized within formatting system 10, additional types could be defined and used. The “translation” element of translation rule defines the output format for all the word defined by the translation rule assuming that formatting system 10 is present within the contextual state associated with the category (e.g. “WordInNumber”).

The NoCheck category is composed solely of the NoCheck context. This means that if a word from working list 35 is read, it is automatically translated into the translation element of the appropriate translation rule. For example, if the word “oh” is read from working list 35 then it is translated into the integer “0”. All of the words contained within the NoCheck category are words that are always translated into the translation element of their translation rule regardless of the particular contextual state of formatting system 10. In formatting system 10, words like “oh”, “five”, “forty” etc. are always translated (i.e. into “0”, “5”, “40”) since they represent numerical expressions that are to be formatted in numerical representation.

The NoCheckPlural category is composed of the NoCheck context which means that the translation rules contained within this category are also automatically executed regardless of what contextual state formatting system 10 is in. In addition, the pseudo-attribute Plural is associated with the category. That is, the words in this category (e.g. “once”, “fluid”, “pint”, “teaspoon”) are all translated into translations (e.g. “oz”, “fl ounce”, “pt”, “tsp”) regardless of whether the word read is singular or plural.

The NoCheckTerminator category is composed of the NoCheck context that means that the translation rules contained within this category are also automatically executed regardless of what contextual state formatting system 10 is in. The category is also associated with the Terminator attribute which means that working list 35 will be processed after a word in this category is read by working list module 18. The words in this category (e.g. “first” and “second”) are all translated into translation elements (i.e. “1” and “2”) and also cause processing of working list 35 when encountered.

The WordInNumber category is composed solely of the WordInNumber context. This means that words contained in the category will only be included on the working list 35 if formatting system 10 is in the WordInNumber contextual state (e.g. a number has just been read). Words in this category (e.g. “hundred” and “decimal”) are only included in working list 35 and translated into integer numerical format (e.g. “100”) or translation string format (e.g. “.”) as appropriate, only if formatting system 10 is in the WordInNumber contextual state.

The WordInNumberPlural category is composed of the WordInNumber context and the Plural pseudo-attribute. Words contained in the category (e.g. “dollar”) are only included on the working list 35 and translated into the translation element string (e.g. “$”) if formatting system 10 is in the WordInNumber contextual state. Such specific formatting rules executed by specific formatting module 20 are typically hard coded into formatting system 10.

The WordInNumberFraction category is composed of the WordInNumber context and the Fraction attribute. Words contained in the category (e.g. “over”) will only be included on the working list 35 and translated into the translation element (e.g. “/”) if formatting system 10 is in the WordInNumber contextual state. Specific formatting module 20 contains additional rules which are used to format fractions, as will be discussed.

The WordInNumberFractionPluralTerminator category is composed of the WordInNumber context which means that words contained in the category will only be included on the working list 35 if formatting system 10 is in the WordInNumber contextual state. The category is also associated with the attribute Fraction and pseudo-attribute Plural as discussed above. Finally, the category is also associated with the Terminator attribute which means that working list 35 will be processed after a word in this category is read by working list module 18. Words in this category (e.g. “half” and “quarter”) are converted to integer numerical representation (e.g. “2” and “4”) when the contextual state is WordInNumber.

The WordInNumberFractionTerminator category is composed of the WordInNumber context which means that words contained in the category will only be included on the working list 35 and processed if formatting system 10 is in the WordInNumber contextual state. The category is also associated with the Fraction and Terminator attributes as discussed above. Words in this category (e.g. “thirds”, “tenths”, etc.) are translated into integer numerical representation (e.g. “3”, “10”) when the contextual state is WordInNumber.

The WordInNumberTime category is composed of the WordInNumber context which means that words contained in the category will only be included on the working list 35 and processed if formatting system 10 is in the WordInNumber contextual state. Words in this category (e.g. “am”, “hours”) are translated into translation strings (“a.m.” and “hr”) when the contextual state is WordInNumber.

The NoCheckDate category is composed of the NoCheck context which means that the translation rules contained within this category are automatically executed regardless of what contextual state formatting system 10 is in. This category also includes the attribute Date. Words in this category (e.g. “january”) are converted into date formatted strings (e.g. “01”) as required.

The WordInNumberTerminator category is composed of the WordInNumber context which means that words contained in the category will only be included on the working list 35 and processed if formatting system 10 is in the WordInNumber contextual state. This category also includes the attribute Terminator which means that words read in this category are used to indicate that processing of working list 35 is due. Words in this category (e.g. “Celsius”) are translated into corresponding strings (e.g. “C”) in the WordInNumber context.

The WordInNumberPluralTerminator category is composed of the WordInNumber context that means that words contained in the category will only be included on the working list 35 and processed if formatting system 10 is in the WordInNumber contextual state. This category also includes the pseudo-attribute Plural and the attribute Terminator as discussed above. Words in this category (e.g. “centimeter”, “yard”) are translated into appropriate string representations (e.g. “cm”, “yd”) in the WordInNumber state.

The NoCheckFractionTerminator category is composed of the NoCheck context that means that the translation rules contained within this category are also automatically executed regardless of what contextual state formatting system 10 is in. The category is also associated with the Terminator attribute as discussed above. Words in this category (e.g. “third”, “tenth”) are translated into their fraction numerical representations (e.g. “3”, “10”) regardless of state.

The NoCheckPrefix category is composed of the NoCheck context and the Prefix attribute. The Prefix attribute indicates that the words in the category (e.g. “numeral”, “\hyphen”, etc.) are translated into translation strings (e.g. “”, “\hyphen”) as desired. As noted above, Prefix words are used to indicate that another expression is beginning and that the previous expression (should there be one) should be processed.

The NoCheckPrefixTerminator category is composed of the NoCheck context, and the Prefix and Terminator attributes as discussed above this category can be used to force the processing of one specifically defined word (e.g. a profanity) on its own.

Referring now back to FIG. 4A, in the example discussed above, the word (“centimeter”) is located within the category (“WordInNumberPluralTerminator”). Assuming that the contextual state of formatting system 10 is “WordInNumber” (i.e. a word considered “significant” has preceded the word “centimeter” such as for example “five”), when the word “centimeter” is read by next word reader module 12, it will be identified as a word to be added to working list 35. Since “centimeter” is within a category that includes the attribute “Terminator”, add to working list module 16 will also cause working list module 18 to process the working list 35. Upon processing, specific formatting module 20 will translate the word(s) preceding “centimeter” (e.g. “twenty”, “five”) into the composite translation “25” and then the word “centimeter” is translated into the translation “cm”. The resulting formatted word list 25 then will contain the string “25 cm”. It should be noted that words like “centimeter” (e.g. “kilobyte”) are grouped into the “WordInNumberPluralTerminator” category to increase the efficiency of formatting system 10. Specifically, words located within a particular category are translated into a formatted expression using similar formatting techniques.

It should be understood that additional and/or different context match types, context indicia and attributes could be used to form additional categories in order to achieve desired formatting results. In the example formatting system 10 discussed, there is only one category for a given word, but it should be understood that a word could be associated with multiple categories. In addition, it is contemplated that each word that is processed by next reader module 12 could be associated with a context match type that would be applied to the word following. This type of approach would allow for such formatting functionality as two spaces after a period, one space after a comma, and the like. Such formatting rules could be preset within dictionary database 24 and then configurable using settings in configuration file 26.

FIG. 4C is a sample configuration file 26. As previously discussed, configuration file 26 is used to overwrite translation rules within dictionary database 24 at startup. Also as previously discussed, by adding a translation rule that translates a particular word into the identical word within any NoCheck category (e.g. the NoCheckPrefixTerminator), it is possible to prevent any perceptible processing of that word within formatting system 10. As shown in FIG. 4C, the inclusion of the translation rule “fahrenheit=S˜fahrenheit” within the NoCheckPrefixTerminator ensures that the word “fahrenheit” is only ever changed to “fahrenheit” (i.e. not changed at all).

Specifically, at startup the translation rule “fahrenheit=S˜fahrenheit” within the configuration file 26 is used to overwrite any translation rule that involves the defined word “fahrenheit”. Then when next word reader module 12 reads the word “fahrenheit” and sends it to add to working list module 16, add to working list module 16 checks to see whether the word “fahrenheit” is a defined “word” in a translation rule within dictionary database 24. Since the translation rule has been set to be “fahrenheit=S˜fahrenheit” by configuration file 26, the word “fahrenheit” is replaced by itself.

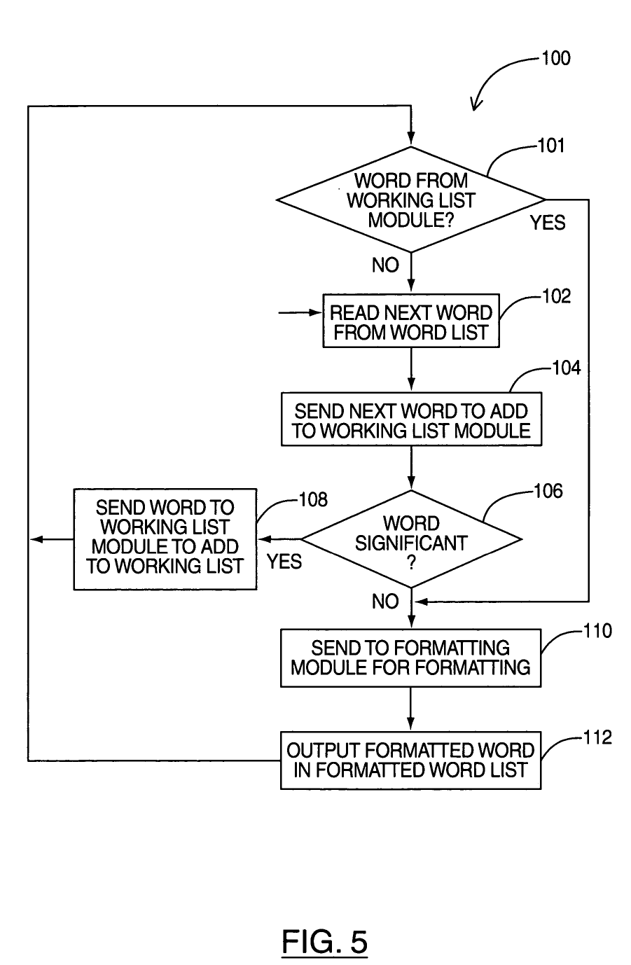

FIG. 5 illustrates the general operation steps (100) executed by next word reader module 12 as words are received from word list 15, to coordinate the inputs and outputs from add to working list module 16 and specific formatting module 20 such that a properly formatted string of words are provided within formatted word list 25.

At step (102), next word reader module 12 obtains the next word from word list 15 from speech recognition engine 11 (e.g. “the”). At step (104), next word module 12 sends the word to add to working list module 16. At step (106), add to working list module 16 determines whether the word is considered “significant” (e.g. “twenty”). If so, then at step (108), next reader module 12 sends word to working list module 18 so that it can be added to working list 35. If the word is not considered “significant” (e.g. “range”), then at step (110), next word reader module 12 sends word to formatting module 14 for formatting (e.g. to “_range”). At step (112) formatting word from formatting module 14 is outputted within formatted word list 25.

At step (101), next word reader module 12 checks to see if there is a word being sent from working list module 18. As noted above, when a word is identified by add to working list module 16 as being “significant” at step (106), the word is sent at step (108) to working list module 18 to be added to working list 35. Other significant words are then added to the working list 35 until a Terminator word (i.e. either a defined Terminator word or a word that is not an defined “word” for any translation rules in dictionary database 24) is encountered in word list 15. When this occurs, working list module 18 is then triggered to process the working list 35.

Specific formatting module 20 is used to format the words as part of the overall processing of working list 35 by working list module 18. These formatted words are then provided one by one by working list module 18 to next word reader module 12 for formatting by formatting module 14. Typically, a number of words which are not deemed to be “significant” are formatted by formatting module 14 and output into formatted word list 25 in turn until “significant” words (i.e. associated with an expression) are encountered in word list 15. Once an expression is encountered, each “significant” word is compiled in working list 35 until an insignificant, Terminator, or Prefix word within word list 15 is read as discussed above. At this point the words are formatted by specific formatting module 20 and the resulting formatted words are provided to next word reader module 12 for general formatting within formatting module 14 and output into formatted word list 25. Once again, at step (102) once all words form working list 35 have been processed, next word reader module 12 will then read words from word list 15.

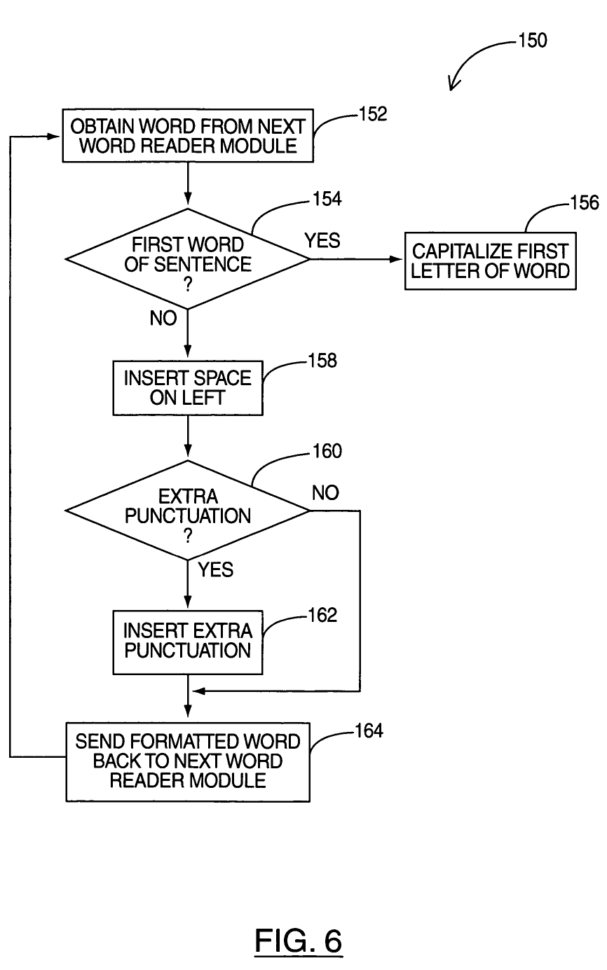

FIG. 6 illustrates the general operation steps (150) executed by formatting module 14 to provide general formatting to a word provided by next word reader module 12.

At step (152), formatting module 14 receives a word from next word reader module 12. At step (154), it is determined whether the word is the first word of a sentence (e.g. “the” in FIG. 1). If so, then at step (156), the first letter of the word is capitalized (e.g. “The” in FIG. 1). If not (e.g. “range”), then at step (158), a space is inserted on the left of the word (e.g. “_range”).

At step (160), it is determined whether additional punctuation is required to be associated with a word. Punctuation words are received from work list 15 and have a particular format (e.g. “.\period”). Punctuation words are read and converted into conventional punctuation format (e.g. “.”) by formatting module 14. Other types of keyboard commands (e.g. “\all-caps-on”) are also read and interpreted by formatting module 14 as their formatting equivalents (e.g. turning on the cap lock key so that all words are capitalized). If extra punctuation is required (due possibly to changes in the word order due to processing of working list 35), then at step (162), appropriate punctuation is added into the word string. If not, then at step (152), the next word is obtained from the next word reader module 12.

As discussed above, it is contemplated that each word that is processed by next reader module 12 could be associated with a context inidica that would be applied to the following word. This type of approach would allow for such formatting functionality as two spaces after a period, one space after a comma, and the like. This approach could be preset within dictionary database 24 and configurable using settings in configuration file 26.

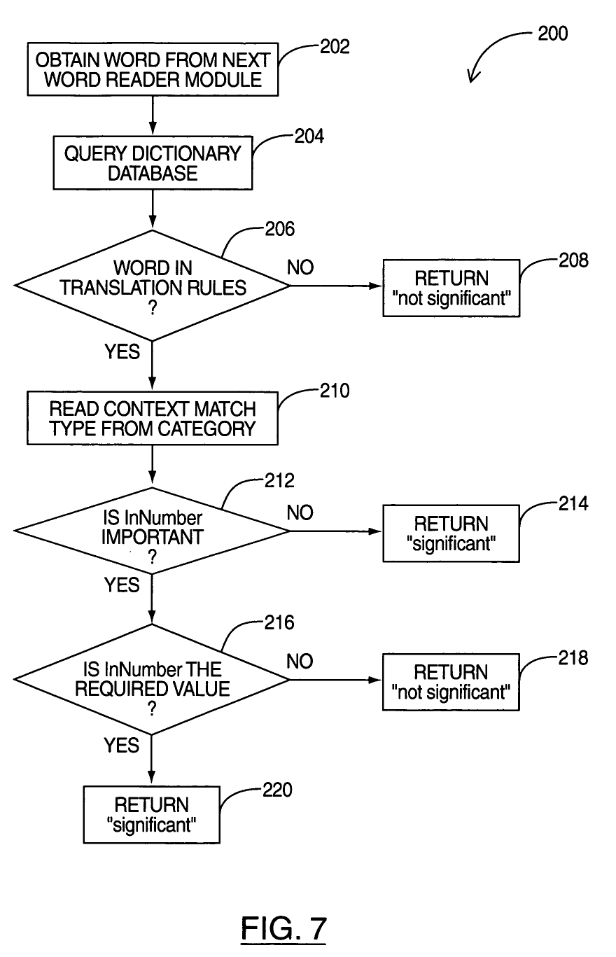

FIG. 7 illustrates the general operation steps (200) of add to working list module 16 which are executed to determine whether a word obtained from next word reader module 12 is “significant” or not. It should be understood that as part of this process, the context of formatting system 10 is updated according to the word read and any changes in the values of the associated context indicia discussed above.

At step (202), add to working list module 16 receives the next word (e.g. “centimeters” is the next word and the word “five” was previously read) from next word reader module 12. At step (204), add to working list module 16 queries dictionary database 24 to determine whether the word at issue (e.g. “centimeters”) corresponds to a defined “word” within a translation rule contained in dictionary database 24. If at step (206), the word does not correspond to a defined “word” within a translation rule of dictionary database 24, then at step (208), add to working list module 16 returns “not significant” to next word reader module 12. That is, dictionary database 24 does not include a listing for the word and so it will not be included in working list 35. As will be described, at this point, next word reader module 12 will then simply the cause formatting module 14 to format the word and to output the work in formatted word list 25.

If at step (206), the word (e.g. “centimeters”) corresponds to a defined “word” within a translation rule of dictionary database 24, then at step (210) the context match type is determined from the category in which the word has been located within dictionary database 24. In the present example, the word “centimeters” is listed within the WordInNumberPluralTerminator category in dictionary database 24 (see Table D) and so WordInNumber is the context match type associated with this category.

At step (212), it is determined whether the InNumber context indicia is important to the context match type. If the InNumber context indicia is not important to the context match type then at step (214), the result “significant” is returned by add to working list module 16 to next word reader module 12. If the InNumber context indicia is considered to be important to the WordInNumber context match type then at step (216), it is determined whether the value of the InNumber context indicia associated with the context of formatting system 10 is equal to the required value associated with the context match type. If not, then at step (218), the result “not significant” is returned by add to working list module 16 to next word reader module 12. If so, then at step (220), the result “significant” is returned by add to working list module 16 to next word reader module 12.

In the example case, assuming that the word “is” has just been read and the word “twenty” is being read. As described above, since the word “is” is not a word in the translation rules of dictionary database 24, the word “is” will have been determined to be “not significant’. However, since the word “five” is a word in the translation rules of dictionary database 24, the word “five” will be further analyzed. The context match type associated with the category in which the word “five” was located is NoCheck (see Table D). Accordingly, it will be determined at step (212) that the InNumber context indicia is not important to the NoCheck context match type (no context indicia is) and the word will be found to be “significant”. When the word “centimeters” is read, at step (210) the associated context match type from dictionary database 24 will be WordInNumber (see Table D). It will be determined at step (212) that the InNumber context indicia is important to the WordInNumber context match type and at step (216), the value of the InNumber context indicia will be checked to see if the InNumber context indica is the value required. Since the value of the InNumber context indicia at this point is “TRUE” (since the word “centimeters” is in a numerical expression) and matches the required value, the word “centimeter” is considered significant by add to working list module 16.

It should be understood that in this example implementation of formatting system 10 there are only two context match types (NoCheck and WordInNumber) and that they are differentiated only by whether the context inidica InNumber is important or not. However, it should be understood that a number of context indicia could be utilized to differentiate a number of context match types. In such a case, the determinations in steps (212) and (216) would be extended accordingly.

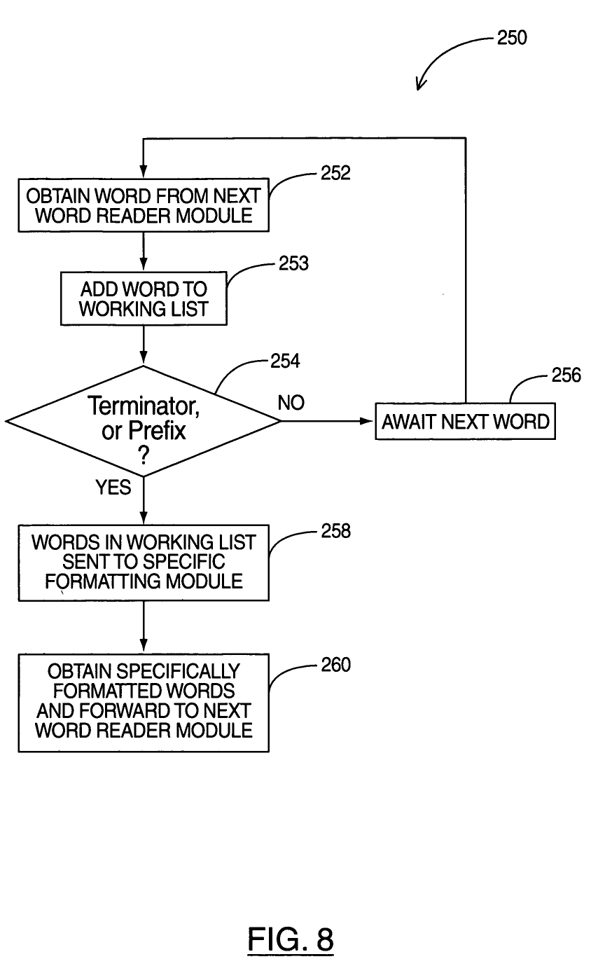

FIG. 8 illustrates the general operation steps (250) of working list module 12 of formatting system 10. At step (252), a word from word list 15 is obtained from next word reader module 12. The word has been provided by next word reader module 12 to working list module 18 because the word has been determined by add to working list module 16 to be a “significant” word (as determined by the process in FIG. 7). Accordingly, at step (253), the word is added to working list 35.

At step (254), it is determined whether the word is a Terminator or a Prefix word. As discussed before, this requires determining whether the word is defined as Terminator or a Prefix word in dictionary database 24. For this purpose, the word must either be defined within a category that has the “Terminator” and/or “Prefix” attribute. If the word is not a Terminator or Prefix word then at step (256), the routine returns to next word reader module 12 and awaits the next word from word list 15 to be processed by next word reader module 12.

If at step (254), the word is a Terminator or a Prefix word, then starting at step (258) working list module 18 will begin processing working list 35 that has been compiled. Specifically, at step (258), the words in working list 35 are sent to specific formatting module 20 for formatting according to various context-dependent rules as will be described. At step (260), the specifically formatted rules are obtained from specific formatting module 20 and sent to next work reader module 12 for general formatting and output to formatted word list 25.

Specific formatting module 20 is used to format the words within working list 35 by processing the words in a left to right manner using various formatting types and by applying general rules, as will be described. The following approach has been adopted for use within formatting system 10 but it should be understood that many other formatting techniques could be utilized within formatting system 10 to achieve effective translation. Assuming that the various words in working list 35 have been translated according to the translation rules of dictionary database 24, specific formatting module 20 organizes the translated words into various formatting types as shown in Table E.

TABLE E
Formatting Type

| Formatting Type | Meaning | Example |
|---|---|---|
| whole number | word(s) read are part of | 123 |
| | a whole number | |
| decimal | word(s) read are part of | 2.5 |
| | a decimal number | |
| fractional | word(s) read are part of | ⅖ |
| | a fractional value | |
| numerator | word(s) read are part of | ⅗ |
| | a numerator | |
| over | word following goes into | ⅗ |
| | the denominator | |
| denominator | word(s) read are part of | ⅗ |
| | a denominator | |

Specific formatting module 20 takes the words in working list 35 and then combines them and assigns them to various formatting types. In doing so, it is possible for working list 35 to be broken into two or more sub-working lists. For example, if working list 35 logically represents several distinct numerical expression phrases (e.g. 2.5 and ⅞) then these two numerical expression phrases are handled as two logically separate sub-working lists. In this example, it is noteworthy that specific formatting module 20 is designed only to process one type of numerical expression at one time (i.e. either a decimal or a fraction type).

Generally, numerical expressions are assembled using mathematics. The words “one” “two” “three” in working list 35 is formatted as “123” by calculating the result of 1*10+2*10+3 (BEDMAS isn't applied and the operations take place left to right). Similarly, the words “one” “thousand” “two” “hundred” and “five” is formatted as “1205” by calculating the result of (1*1000)+(2*100+5) (the brackets denote distinct operations). These numbers are then gathered together and assigned to formatting types: “whole number”, “fractional part”, “numerator”, and “denominator” depending on what other words are contained in working list 35.

If a word such as “.\point” or “.\decimal” is read from working list 35 then the formatting type will change from whole number to fractional. If the word “over” is read from working list 35, then the formatting type will change from whole number or numerator to a denominator. Once all of the words in working list 35 have been placed or if it has been decided that working list 35 should be broken apart, the various words in the formatting types are merged together to create one or more logical words. Specifically, they are combined as follows:
[<prefix>[<whole>[.<decimal>] [<numerator>/<denominator>]]<postfix]

Once this process has been completed, there are additional rules that are evaluated. For example, if we only have a whole number, commas may be added to the number to denote the thousands etc. Alternatively, if it is determined that the whole number is in fact a phone number then the symbol ‘-’ will be added at the right points etc.

Formatting system 10 recognizes complicated number in word combinations and efficiently translates them into intelligible textual output through the use of contextual rules. Configuration file 26 allows user to easily and conveniently customize the specific translation rules of formatting system 10 using configuration file 26. This allows formatting system 10 to be easily configurable from a site specific user point of view. This configurability feature can be provided to the user through a user-friendly graphical user interface (GUI) to improve the ease of use.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A configurable formatting system for generating a desired representation of an expression within a word list, said system comprising:
(a) a dictionary database for storing at least one category, said category containing at least one word and at least one translation rule;
(b) a configuration file coupled to the dictionary database containing at least one variant to the contents of at least one category of the dictionary database, said variant to the contents of at least one category being used to overwrite the contents of said at least one category within said dictionary database;
(c) a working list module coupled to the dictionary database for reading a word from the word list and identifying whether a word is associated with the expression by searching the categories of said dictionary database for said word, said working list module being adapted to:
(i) insert the word into a working list if the word is associated with the expression;
(ii) process the word list when the word is associated with the termination of the expression; and
(d) a formatting module coupled to the working list module for processing the words from the working list and generating the desired representation of the expression from the working list.

2. The system of claim 1, wherein working list module utilizes the categories of said dictionary database to identify whether a word is associated with the expression.

3. The system of claim 1, wherein working list module is adapted to be either in a NoCheck state or in a WordInNumber state according to the following:
(i) when word list is empty, working list module is in a NoCheck state;
(ii) working list module enters into a WordInNumber state when the word being read is associated with the expression; and
(iii) working list module returns to the NoCheck state when the word being read is associated with the termination of the expression.

4. The system of claim 3, wherein said working list module is further adapted to determine whether a word is associated with the expression, by:
(iv) determining whether the working list module is in the WordInNumber state;
(v) determining whether the working list module is in the NoCheck state and the word is a numeral; and
(vi) if either (iv) or (v) is true then determining that the word is associated with the expression.

5. The system of claim 1, wherein the word is associated with the termination of an expression when the word is a punctuation character.

6. The system of claim 1, wherein the word is associated with the termination of an expression when the word is not present within any of the categories of the dictionary database.

7. The system of claim 1, wherein said formatting module is adapted to look up the category associated with a word within the dictionary database.

8. The system of claim 7, wherein said formatting module formats the word according to the translation rule associated with the category associated with the word.

9. The system of claim 8, wherein the category for the word is used to format the word in association with another word within working list.

10. A configurable formatting method for generating a representation of an expression within a recognized word list, said method comprising:
(a) storing at least one category in a dictionary database, said category containing at least one word and at least one translation rule;
b) storing at least one variant to the contents of at least one category of the dictionary database in a configuration file and using the contents of at least one category to overwrite the contents of said at least one category within said dictionary database;
(c) reading a word from the word list and identifying whether the word is associated with the expression by searching the categories of said dictionary database for said word;
(d) inserting the word into a working list if the word is associated with the expression;
(e) processing the word list when a word is associated with the termination of the expression; and
(f) formatting the words from the working list and generating the desired representation of the expression from the working list.

11. The method of claim 10, wherein the categories of said dictionary database are used to identify whether a word is associated with the expression.

12. The method of claim 10, wherein (c) further comprises moving between a NoCheck state or in a WordInNumber state according to the following:
(i) when word list is empty, being in a NoCheck state;
(ii) entering into a WordInNumber state when the word being read is associated with the expression; and
(iii) returning to the NoCheck state when the word being read is associated with the termination of the expression.

13. The method of claim 10, wherein (c) further comprises:
(iv) determining whether the working list module is in the WordInNumber state;
(v) determining whether the working list module is in the NoCheck state and the word is a numeral; and
(vi) if either (iv) or (v) is true then determining that the word is associated with the expression.

14. The method of claim 10, wherein the word is associated with the termination of an expression when the word is a punctuation character.

15. The method of claim 10, wherein the word is associated with the termination of an expression when the word is not present within any of the categories of the dictionary database.

16. The method of claim 10, wherein (f) further comprises looking up the category associated with a word within the dictionary database.

17. The method of claim 16, wherein the category associated with the word is used to format the word in association with another word within working list.
